(19) United States
(12) Patent Application Publication
(10) Pub. No.: US 2016/0010532 A1
(43) Pub. Date: Jan. 14, 2016

(54) CATALYST ASSEMBLY WITH INTEGRATED EMISSIONS SAMPLING PROBE

(71) Applicant: General Electric Company, Schenectady, NY (US)

(72) Inventors: Dennis John Spaulding, Waukesha, WI (US); Joshua James Lavalle, Waukesha, WI (US)

(21) Appl. No.: 14/328,303

(22) Filed: Jul. 10, 2014

(51) Int. Cl. F01N 11/00; B01D 53/94

(52) U.S. Cl. CPC F01N 11/007; B01D 53/9454; F01N 2550/02

(57) ABSTRACT

A system includes a catalyst assembly configured to mount along an exhaust flow path of a reciprocating combustion engine. The catalyst assembly includes a housing having an inlet, an outlet, and a flow path between the inlet and the outlet. The catalyst assembly also includes or more catalyst elements disposed in the housing along the flow path. The catalyst assembly further includes an emissions sampling probe integrated within the housing along the flow path.

### BACKGROUND

The subject matter disclosed herein relates to reciprocating engines and, more specifically, to monitoring emissions of reciprocating engines.

Engines (e.g., internal combustion engines such as gas engines) combust a mixture of fuel and air to generate combustions gases that apply a driving force to a component of the engine (e.g., to move a piston). Subsequently, the combustion gases exit the engine as an exhaust gas. Unfortunately, without suitable treatment, the exhaust gas may include a variety of undesirable emissions, such as nitrogen oxides (NOₓ), sulfur oxides (SOₓ), hydrocarbons (HC), and carbon monoxide (CO).

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a catalyst assembly configured to mount along an exhaust flow path of a reciprocating combustion engine. The catalyst assembly includes a housing having an inlet, an outlet, and a flow path between the inlet and the outlet. The catalyst assembly also includes one or more catalyst elements disposed in the housing along the flow path. The catalyst assembly further includes an emissions sampling probe integrated within the housing along the flow path.

In accordance with a second embodiment, a system includes a reciprocating combustion engine. The system also includes a catalyst assembly coupled to an exhaust flow path of exhaust from the reciprocating combustion engine. The catalyst assembly includes an inlet configured to receive an exhaust flow from the reciprocating combustion engine, one or more catalyst elements configured to treat the exhaust flow, an outlet configured to discharge the treated exhaust flow, and an emissions sampling probe integral to the catalyst assembly disposed between the inlet and the outlet.

In accordance with a third embodiment, a system includes a reciprocating combustion engine. The system also includes a catalyst assembly coupled to an exhaust flow path of exhaust from the reciprocating combustion engine. The catalyst assembly includes a housing that includes a wall having a port. The catalyst assembly also includes a catalyst element disposed in the housing along a flow path of the exhaust. The catalyst assembly further includes an emissions sampling probe that extends through the port, wherein a first portion of the emissions sampling probe is exposed to the flow path to collect a sample of the exhaust upstream or downstream of the catalyst element, and a second portion of the emissions sampling probe is configured to couple to an emissions analyzer for analysis of the sample.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an engine driven system (e.g., engine driven power generation system) coupled to an aftertreatment system having an integral emissions sampling probe;

FIG. 2 is a cross-sectional side view of an embodiment of a catalyst assembly having integrated emissions sampling probes;

FIG. 3 is a cross-sectional side view of an embodiment of an emissions sampling probe integrated within the catalyst assembly (e.g., via a compression fitting), taken within line 3-3 of FIG. 2; and

FIG. 4 is a cross-sectional side view of an embodiment of an emissions sampling probe integrated within the catalyst assembly (e.g., welded), taken within line 3-3 of FIG. 2.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems that integrate (e.g., into a single unit) at least one emissions sampling probe with an exhaust treatment system, such as a catalyst assembly. In particular, embodiments of the present disclosure include a catalyst assembly (e.g., three-way catalyst) configured to couple to and receive exhaust from an internal combustion engine (e.g., a reciprocating engine such as a gas engine). The catalyst assembly includes a housing and one or more catalyst elements. The housing of the catalyst assembly includes a wall that includes one or more ports. Emissions sampling probes extend through the ports and the wall. For example, the emissions sampling probe includes a first portion that extends into exhaust flow to collect a sample (e.g., of exhaust flow or treated exhaust flow) and a second portion disposed outside the housing that is configured to couple to an emissions analyzer. One or more emissions sampling probes may be disposed between the inlet and the outlet of the catalyst assembly upstream and/or downstream of the one or more catalyst elements of the catalysts assembly. In certain embodiments, the emissions sampling probe may be coupled to and extend through the port via a compression fitting. In other embodiments, the emissions sampling probe may be coupled to the port via welding. Providing the emissions sampling probe as part of the catalyst assembly enables consistent emissions readings of emissions within the exhaust flow or the treated exhaust flow. In addition, providing an integrated emissions sampling probe avoids inappropriate probes installed on the catalyst assembly or probes being incorrectly installed.

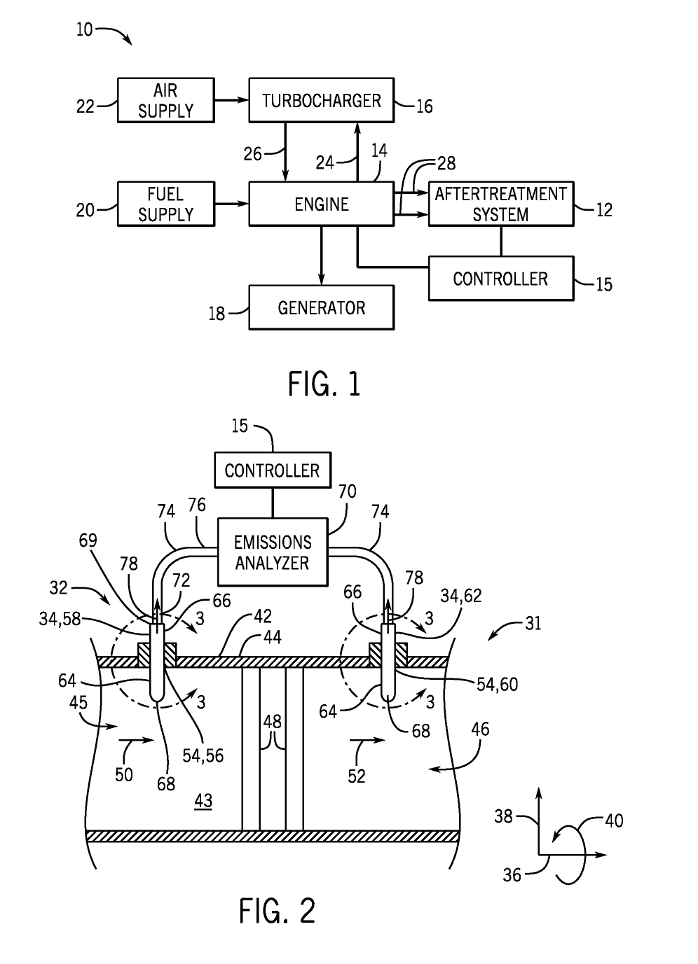

Turning now to the drawings and referring first to FIG. 1, a block diagram of an embodiment of an engine driven system 10 (e.g., engine driven power generation system) coupled to an aftertreatment or exhaust treatment system 12 is illustrated. As described in detail below, the disclosed engine driven system 10 utilizes an engine 14 coupled to the aftertreatment system 12. The engine 14 may include a reciprocating or piston engine (e.g., internal combustion engine). The engine 14 may include a spark-ignition engine or a compression-ignition engine. The engine 14 may include a natural gas engine, gasoline engine, diesel engine, or dual fuel engine. The engine 14 may be a two-stroke engine, three-stroke engine, four-stroke engine, five-stroke engine, or six-stroke engine. The engine 14 may also include any number of cylinders (e.g., 1-24 cylinders or any other number of cylinders) and associated piston and liners. The system 10 may generate power ranging from 10 kW to 10 MW. Exemplary engines 14 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example. The engine 14 is coupled to a controller 15 that controls the operation of the engine 14 (e.g., fuel/air ratio, fuel injection timing, ignition timing, etc.). In certain embodiments, the controller 15 may also be coupled to the aftertreatment system 12.

The aftertreatment system 12 may include a catalytic converter or catalyst assembly (e.g., TWC assembly) to treat or reduce emissions within the exhaust generated by the engine 14. The catalyst assembly includes a housing having a wall with one or more ports. One or more emissions sampling probes are integrated within the housing of the catalyst assembly. For example, the emissions sampling probes are disposed within the ports with a first portion of each probe disposed within the exhaust flow within the catalyst assembly and a second portion of each probe disposed outside of the housing. The first portion of each probe includes one or more ports (e.g., sample or collection ports) that enable collection of a sample of the exhaust flow or treated exhaust flow (i.e., treated via one or more catalyst elements within the housing of the catalyst assembly). The second portion of each probe is configured to couple to an emissions analyzer that analyzes the collected sample. In certain embodiments, the emission analyzer may provide feedback related to the emissions to the controller 15 of the engine 14 that may alter the operation of the engine 14. The catalyst assembly includes an inlet to receive the exhaust flow generated by the engine 14, one or more catalyst elements (e.g., to promote the treatment and reduction of emissions such as NOₓ, SO_{X}, HC, and CO), and an outlet to discharge the treated exhaust flow. One or more of the emissions sampling probes are disposed between the inlet and the outlet of the catalyst assembly. For example, one or more emissions sampling probes may be integrated within the housing of the catalyst assembly only upstream of the catalyst elements. Also, one or more emissions sampling probes may be integrated within the housing of the catalyst assembly only downstream of the catalyst elements. In certain embodiments, emissions sampling probes may be integrated within the housing of the catalyst assembly both upstream and downstream of the catalyst elements. The emissions sampling probes may be fixed (e.g., welded or formed as one piece) to the ports of the wall of the housing. Alternatively, the emissions sampling probes may be disposed within the ports via a removable fitting, such as a compression fitting, a threaded fitting, seals or gaskets, clamps, or a combination thereof. Providing the emissions sampling probe as part of the catalyst assembly enables consistent emissions readings of emissions within the exhaust flow or the treated exhaust flow. In addition, providing an integrated emissions sampling probe avoids inappropriate probes installed on the catalyst assembly or probes being incorrectly installed. In other words, a single unit or unitary structure may include both the catalyst assembly and one or more emissions sampling probes, such that the probes are mounted in suitable and consistent locations relative to catalyst elements of the catalyst assembly.

The power generation system 10 includes the engine 14, a turbocharger 16, and a generator 18 (e.g., electrical generator). In certain embodiments, instead of the generator 18, the engine 14 is coupled to a mechanical drive or machinery. Depending on the type of engine 14, the engine 14 receives fuel 20 (e.g., diesel, natural gas, coal seam gases, associated petroleum gas, etc.) or a mixture of both the fuel 20 and a pressurized oxidant 22, such as air, oxygen, oxygen-enriched air, or any combination thereof. Although the following discussion refers to the oxidant as the air 22, any suitable oxidant may be utilized with the disclosed embodiments. The fuel 20 or mixture of fuel 20 and pressurized air 22 is fed into the engine 14. The engine 14 combusts the mixture of fuel 20 and air 22 to generate hot combustion gases, which in turn drive a piston (e.g., reciprocating piston) within a cylinder liner. In particular, the hot combustion gases expand and exert a pressure against the piston that linearly moves the piston from a top portion to a bottom portion of the cylinder liner during an expansion stroke. The piston converts the pressure exerted by the combustion gases (and the piston's linear motion) into a rotating motion (e.g., via a connecting rod and a crank shaft coupled to the piston). The rotation of the crank shaft drives the electrical generator 18 to generate power. Alternatively, the crank shaft drives a mechanical drive or machinery. In certain embodiments, exhaust 24 from the engine 14 may be provided to the turbocharger 16 and utilized in a turbine portion of the turbocharger 16, thereby driving a compressor of the turbocharger 16 to pressurize the air 22 as indicated by reference numeral 26. As mentioned above, exhaust 28 from the engine 14 is provided to the aftertreatment system 12 for treatment (e.g., the reduction of emissions within the exhaust 28). In some embodiments, the power generation system 10 may not include all of the components illustrated in FIG. 1. In addition, the power generation system 10 may include additional components such as an exhaust stack, silencer, control components, and/or heat recovery components. In certain embodiments, the turbocharger 16 may be utilized as part of the heat recovery components. The system 10 may generate power ranging from 10 kW to 10 MW or greater. Besides power generation, the system 10 may be utilized in other applications such as those that recover heat and utilize the heat (e.g., combined heat and power applications), combined heat, power, and cooling applications, applications that also recover exhaust components (e.g., carbon dioxide) for further utilization, gas compression applications, and mechanical drive applications.

FIG. 2 is a cross-sectional side view of an embodiment of a common unit 31 having a catalyst assembly 32 having integrated emissions sampling probes 34. In the following discussion, reference may be made to a longitudinal or axial direction 36, a radial axis 38, and/or a circumferential axis 40 of the catalyst assembly 32. The catalyst assembly 32 includes a housing 42 having a wall 44 (e.g., annular wall) disposed about an exhaust flow path 43. The catalyst assembly 32 also includes an inlet 45, an outlet 46, and one or more catalyst elements 48 disposed within the housing 42 along the exhaust flow path 43 between the inlet and the outlet 46. The inlet 45 of the catalyst assembly 32 receives an exhaust flow 50 from the engine 14 (e.g., gas engine). The exhaust flow 50 flows along the exhaust flow path 43 in direction 36 (e.g., axially) from the inlet 45 towards the outlet 46. The one or more catalyst elements 48 promote the reduction of emissions within the exhaust flow 50 to generate a treated exhaust flow 52 that flows downstream from the catalyst elements 48 to the outlet 46 in direction 36 (e.g., axially), where the treated exhaust flow is discharged from the catalyst assembly 32 (e.g., to a silencer and/or exhaust stack). The catalyst assembly 32 may include an oxidation catalyst, a carbon monoxide reduction catalyst, a nitrogen oxides reduction catalyst, or any other type of catalyst. In certain embodiments, the catalyst assembly 32 may be a three-way catalyst (TWC) assembly. For example, the catalyst assembly 32, via the catalyst elements 48 and their catalytic activity, reduces NOₓ via multiple reactions. For example, NOₓ may be reduced via CO to generate N₂ and CO₂, NOₓ may be reduced via H₂ to generate NH₃ and water, and NOₓ may be reduced via a hydrocarbon (e.g., C₃H₆) to generate N₂, CO₂, and water. The catalyst assembly 32 may also oxidize CO to CO₂, and oxidize unburnt HC to CO₂ and water. The catalyst elements 48 may include one or more of aluminum oxide, zirconium oxide, silicone oxide, titanium oxide, platinum oxide, palladium oxide, cobalt oxide, mixed metal oxide, or any other type catalytic material.

The wall 44 of the housing 42 of the catalyst assembly includes one or more ports 54 (e.g., lateral or radial ports) disposed upstream and/or downstream of the catalyst assembly 32. Disposed within each port 54 is a respective emissions sampling probe 34. The probes 34 may be disposed at different circumferential 40 and/or axial 36 positions about and along the wall 40 with respect to each other. For example, port 56 includes emissions sampling probe 58 located upstream of both the catalyst elements 48 and the outlet 46 but downstream of the inlet 45. Port 60 includes emissions sampling probe 62 located downstream of both the inlet 45 and the catalyst elements 48 but upstream of the outlet 46. As depicted, emissions sampling probes 34 may be integrated within the housing 42 of the catalyst assembly 32 both upstream and downstream of the catalyst elements 48. In certain embodiments, one or more emissions sampling probes 34 may be integrated within the housing 42 of the catalyst assembly 32 only upstream of the catalyst elements 48 (e.g., to enable analysis of exhaust emissions prior to treatment). In other embodiments, one or more emissions sampling probes 34 may be integrated within the housing 42 of the catalyst assembly 32 only downstream of the catalyst elements 48 (e.g., to enable analysis of exhaust emissions after treatment by the catalyst assembly 32). Any emissions sampling probe 34 located upstream of the catalyst elements 48 (e.g., probe 58) collects a sample of the exhaust flow 50 for emissions analysis. Any emissions sampling probe 34 located downstream of the catalyst elements 48 (e.g., probe 62) collects a sample of the treated exhaust flow 52 for emissions analysis. In certain embodiments, one or more emissions sampling probe 34 (e.g., similar to emissions sampling probes 58, 62) may be integrated within the housing 42 of the catalyst assembly 32 between catalyst elements 48. For example, one or more emissions sampling probes 34 may be integrated within the housing upstream of at least one catalyst element 48 and downstream of at least one catalyst element 48.

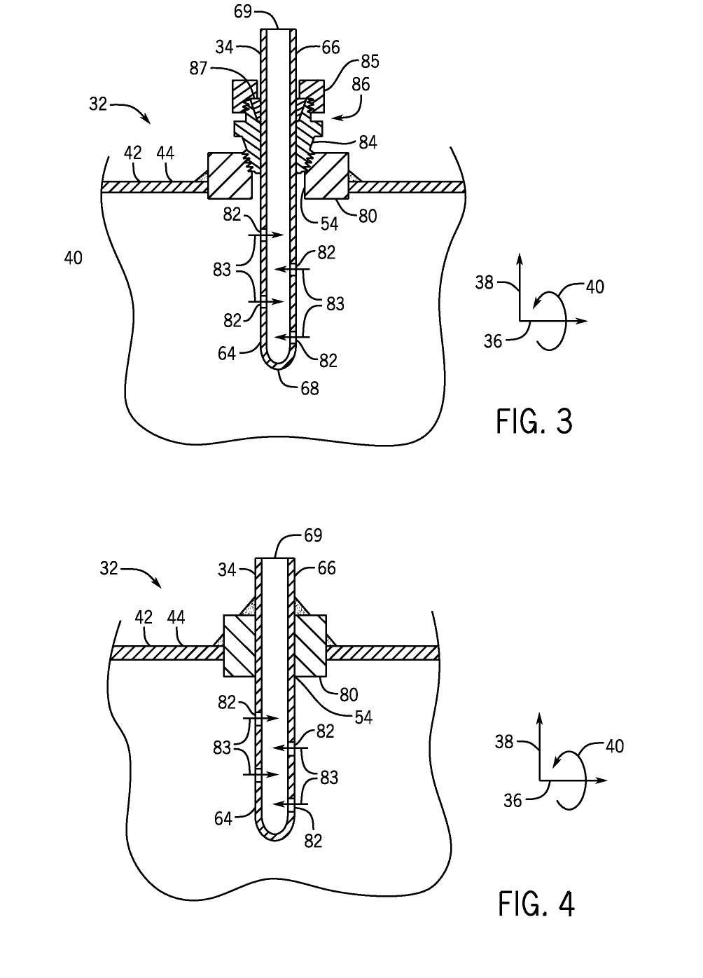

Each emissions sampling probe 34 may include a tubular structure. In certain embodiments, the sampling probe 34 may include an indicator (e.g., scribed mark or etching) that indicates how far (e.g., radially 38) the probe 34 should be inserted within the port 54. Each emissions sampling probe 34 includes a first portion 64 that extends into fluid flow (e.g., exhaust flow 50 or treated exhaust flow 52) within the housing 42 of the catalyst assembly 32. The first portion 64 may include a closed end 68 and one or more ports (e.g., sample or collection ports) to enable the collection of a sample of the exhaust flow 50 or treated exhaust flow 52 within the probe 34. The sample ports may be disposed at any point about the first portion 64. Each emissions sampling probe 34 includes a second portion 66 that extends outside (e.g., radially 38) of the housing 42. The second portion 66 includes an open end 69. The second portion 66 is configured to couple the probe 34 to an emissions analyzer 70. Specifically, the second portion 66 couples to a first end 72 of a tube 74, while the second end 76 of the tube 74 is coupled to the emissions analyzer 70. The first end 72 of the tube 74 and the end 69 of the probe 34 may be coupled in a variety of ways. For example, the first end 72 of the tube 74 may fit within the end 69 of the probe 34 via an interference fit or vice versa. Alternatively, both the end 72 of the tube 74 and the end 69 of the probe 34 may form a threaded connection (e.g., male and female threads) with both ends 69, 72 having threads (e.g., on an outside or inside surface). Further, a clamp or other fastening device may be used to secure the ends 69, 72 together. The probe 34 may be disposed within and coupled to the port 54 via a variety of mounts. For example, the probe 34 may be disposed or removably mounted within the port 54 via a compression fitting (see FIG. 3), a threaded fitting, press-fit, seals or gaskets, clamps or any combination thereof. Alternatively, the probe 34 may be fixedly coupled (e.g., welded) to the port 54 (see FIG. 4).

Upon collection of a sample, the sample travels through the first and second portions 64, 66 of the emissions sampling probe 34 and into the tube 74 (as indicated by arrow 78) and flows toward the emissions analyzer 70. The emissions analyzer 70 analyzes the emissions (e.g., type of emission and concentration) within the sample (e.g., exhaust flow 50 sample or treated exhaust flow 52 sample). The type of emissions analyzed may include NO_{X}, SO_{X}, HC (e.g., unburnt fuel), CO, NH₃, and/or other emissions. In certain embodiments, the emissions analyzer 70 may be coupled to the controller 15 and provide feedback about the emissions. For example, the controller 15 may regulate control measures based on emission levels (i.e., feedback from the emissions analyzer 70). For example, the controller 15 may adjust fuel/air ratio, fuel injection timing, ignition timing, diesel emissions fluid, urea, and/or other control measures. The emissions analyzer 70 may be utilized for a number of functions. Some of these functions may include analyzing emissions emitted by the engine 14 prior to treatment and/or analyzing emissions after treatment. This information may be utilized to access the performance of the engine 14, fuel utilized with the engine 14, the performance of the catalyst assembly 32 (e.g., for aging or deactivation), emissions compliance, control purposes, and as well as other purposes. As mentioned above, providing the emissions sampling probe 34 as part of the catalyst assembly 32 enables consistent emissions readings of emissions within the exhaust flow or the treated exhaust flow. In addition, providing an integrated emissions sampling probe 34 avoids inappropriate probes installed on the catalyst assembly 32 or probes being incorrectly installed.

As mentioned above, the probe 34 may be disposed within and coupled to the port 54 via a variety of mounts. FIGS. 3 and 4 provide examples of different mounts for fastening the probe to the port 54. In FIGS. 3 and 4, the catalyst assembly 32 and the emissions sampling probe 34 are as described above. For example, the wall 44 of the housing 42 includes the port 54 for receiving the probe 34. In certain embodiments, the port 54 may be formed by a tap 80 (e.g., annular tap, flange, or mounting plate) welded to or integrally formed as one-piece with the wall 44 that includes the port 54. Also, the emissions sampling probe 34 includes the first portion 64 disposed in the fluid flow within the housing 42. The probe 34 includes multiple ports 82 (e.g., sample or collection ports) on the first portion 64 to collect a sample of the exhaust flow or treated exhaust flow as indicated by the arrows 83. As illustrated in FIG. 3, a compression fitting 86 (e.g., annular fitting) is disposed within the port 54, while the probe 34 extends through both the fitting 86 and the port 54 so that the first portion 64 is disposed within the housing 42 and the second portion 66 is disposed outside of the housing 40. The compression fitting 86 includes a first annular fitting 84 threaded to the tap 80, a second annular fitting 85 threaded to the first annular fitting, and an annular compression washer (e.g., a taper annular washer or conical washer) disposed between the fittings 84, 85. The fittings 84, 85 are threaded together such that the compression washer 87 is wedgingly engaged to compress about the probe 34. As illustrated in FIG. 4, the probe 34 also extends through the port 54 so that the first portion 64 is disposed within the housing 42 and the second portion 66 is disposed outside of the housing 42, but the probe 34 is welded directly to the port 54. In certain embodiments, a flange with a copper washer/o-ring seal may be disposed within with the port 54 and utilized to couple the probe 34 to the housing 42. Alternatively, a crushed flare configured to flare out further upon the tightening of a seal may be disposed within the port 54 and utilized to couple the probe 34 to the housing 42.

Technical effects of the disclosed embodiments include providing a system that integrates one or more emissions sampling probe 34 into the housing 42 of the catalyst assembly 32. The system may include one or more emissions sampling probes 34 integrated within the housing 42 upstream, downstream, or both upstream and downstream of one or more catalyst elements 48 and/or between two or more catalyst elements 48 of the catalyst assembly 32. Providing the emissions sampling probe 34 as part of the catalyst assembly 32 enables consistent emissions readings of emissions within the exhaust flow or the treated exhaust flow. In addition, providing an integrated emissions sampling probe 34 avoids inappropriate probes installed on the catalyst assembly 32 or probes being incorrectly installed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A three-way catalyst (TWC) assembly configured to mount along an exhaust flow path of a reciprocating combustion engine, comprising:
a housing comprising an inlet, an outlet, a wall, and a port disposed along the wall between the inlet and the outlet, and a flow path between the inlet and the outlet;
one or more catalyst elements disposed in the housing along the flow path; and
an emissions sampling probe integrated within the housing along the flow path, wherein the emissions sampling probe comprises a tube disposed within the port, a first portion of the tube extends through the wall into the flow path within the housing, and a second portion of the tube extends through the wall outside of the housing.

2. (canceled)

3. The TWC assembly of claim 1, wherein the first portion of the tube comprises one or more sampling ports for collecting a portion of an exhaust from the reciprocating combustion engine within the emissions sampling probe.

4. (canceled)

5. The TWC assembly of claim 3, wherein the second portion of the tube is configured to couple to an emissions analyzer and to provide the collected portion of the exhaust to the emissions analyzer.

6. The TWC assembly of claim 1, wherein the emissions sampling probe is integrated within the housing upstream of each of the one or more catalyst elements.

7. The TWC assembly of claim 1, wherein the emissions sampling probe is integrated within the housing downstream of the one or more catalyst elements.

8. The TWC assembly of claim 1, comprising a plurality of emissions sampling probes integrated within the housing, wherein a first emissions sampling probe of the plurality of emissions sampling probes is integrated within the housing upstream of each of the one or more catalyst elements, and a second emissions sampling probe of the plurality of emissions sampling probes is integrated within the housing downstream of each of the one or more catalyst elements.

9. (canceled)

10. The TWC assembly of claim 1, wherein the emissions sampling probe is removably coupled to the port.

11. The TWC assembly of claim 1, wherein the emissions sampling probe is fixedly coupled to the port.

12. The TWC assembly of claim 1, wherein the emissions sampling probe is integrated within the housing downstream of at least one of the one or more catalyst elements and upstream of at least one of the one or more catalyst elements.

13. A system, comprising:
a reciprocating combustion engine;
a three-way catalyst (TWC) assembly coupled to the reciprocating combustion engine, wherein the catalyst assembly comprises:
an inlet configured to receive an exhaust flow from the reciprocating combustion engine;
one or more catalyst elements configured to treat the exhaust flow;
an outlet configured to discharge the treated exhaust flow; and
an emissions sampling probe integral to the TWC assembly disposed between the inlet and the outlet, wherein the catalyst assembly comprises a housing and a port disposed on the housing between the inlet and the outlet, and the emissions sampling probe is disposed within the port, and wherein the emissions sampling probe comprises a tube disposed within the port, a first portion of the tube extends through a wall of the housing into an interior of the housing, and a second portion of the tube extends through the wall outside of the housing.

14. (canceled)

15. The system of claim 13, wherein the emissions sampling probe is disposed downstream of the inlet and upstream of the one or more catalyst elements.

16. The system of claim 13, wherein the emissions sampling probe is disposed downstream of the one or more catalyst elements and upstream of the outlet.

17. The system of claim 13, wherein the TWC assembly comprises a plurality of emissions sampling probes integral to the TWC assembly and disposed between the inlet and the outlet.

18. (canceled)

19. A system, comprising:
a reciprocating combustion engine; and
a three-way (TWC) assembly coupled to an exhaust flow path of exhaust from the reciprocating combustion engine, wherein the catalyst assembly comprises:
a housing comprising a wall having a port;
a catalyst element disposed in the housing along the exhaust flow path of the exhaust;
an emissions sampling probe comprising a tube that extends through the port, wherein a first portion of the tube is exposed to the exhaust flow path to collect a sample of the exhaust upstream or downstream of the catalyst element, and a second portion of the tube extends through the wall outside the housing and is configured to couple to an emissions analyzer for analysis of the sample.

20. The system of claim 19, wherein the TWC assembly comprises a compression fitting disposed within the port, and the tube extends through both the compression fitting and the port.
